(19) United States
(12) Patent Application Publication
(10) Pub. No.: US 2026/0292291 A1
(43) Pub. Date: Sep. 24, 2026

(54) DYNAMIC PRESENTATION OF PERSONAL INFORMATION DURING PRESENTATION OF AUDIOVISUAL CONTENT

(71) Applicant: DISH Network L.L.C., Englewood, CO (US)

(72) Inventor: Andrea Charlotte Barros, Denver, CO (US)

(21) Appl. No.: 19/087,117

(22) Filed: Mar. 21, 2025

(51) Int. Cl. H04N 21/431; G06F 16/735; G06V 40/16; H04N 21/25

(52) U.S. Cl. CPC H04N 21/431; G06F 16/735; G06V 40/172; H04N 21/251

(57) ABSTRACT

Systems and methods for dynamically presenting personal information associated with people shown in content being presented to a user. While the content is being presented to the user, the user provides an information request regarding an individual being shown in the content. This request may be a voice command or question that is captured by a microphone. In response to receiving the request, a facial recognition mechanism is employed on the content to identify the person being shown in the content. Information on the identified person is then obtained and presented to the user along with the content.

### BACKGROUND

Today, people consume audiovisual content for a variety of reasons. Some people watch live television broadcasts, some people watch streaming services, and some people watch on-demand content. Regardless of how people consume content, the large incentive for people to watch content is to be entertained. But people often crave more content or information related to what they are watching. Unfortunately, traditional audiovisual content services generally cannot provide this additional content or information. It is with respect to these and other considerations that the embodiments described herein have been made.

### BRIEF SUMMARY

Embodiments are directed to dynamically presenting personal information associated with people shown in content being presented to a user. While the content is being presented to the user, the user provides an information request regarding an individual being shown in the content. This request may be a voice command or question that is captured by a microphone. In response to receiving the request, a facial recognition mechanism is employed on the content to identify the person being shown in the content. Information on the identified person is then obtained and presented to the user along with the content.

As an illustrative example, a user may be watching a live broadcast of a television awards show. While watching the show, the user may see a person or individual in the audience that they recognize, but don't know who they are or movies that they have been in. The user pushes a button on a remote control and says “who is the person sitting at the left side of the table” into a microphone of the remote control. The system captures the video frame at the time the user pushes the button (or a plurality of video frames before the user pushes the button to take into account a delay in the user seeing the individual and providing the input). The system provides the question asked by the user and the captured video frame to a trained machine learning mechanism, which performs facial recognition on the video frame to identify the individual that the user is asking about. The system can then use the identity of the individual to query a database to obtain personal information on the individual. The system displays the obtained information to the user along with the live broadcast of the television awards show. In this way, the user can continue watching the television awards show live and see additional information about individuals in the audience and without having to utilize a smartphone or other device to determine who the individual is and obtain such information.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for dynamically presenting personal information associated with individuals shown during presentation of content in accordance with embodiments described herein.

FIG. 2 illustrates a block diagram showing one embodiment of a system for dynamically presenting personal information associated with individuals shown during presentation of content in accordance with embodiments described herein.

FIG. 3 illustrates a logical flow diagram showing one embodiment of a process for dynamically presenting personal information associated with individuals shown during presentation of content in accordance with embodiments described herein.

FIG. 4 illustrates a logical flow diagram showing one embodiment of a process for crowdsourcing personal-information requests to select target content for a target user in accordance with embodiments described herein.

FIG. 5 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

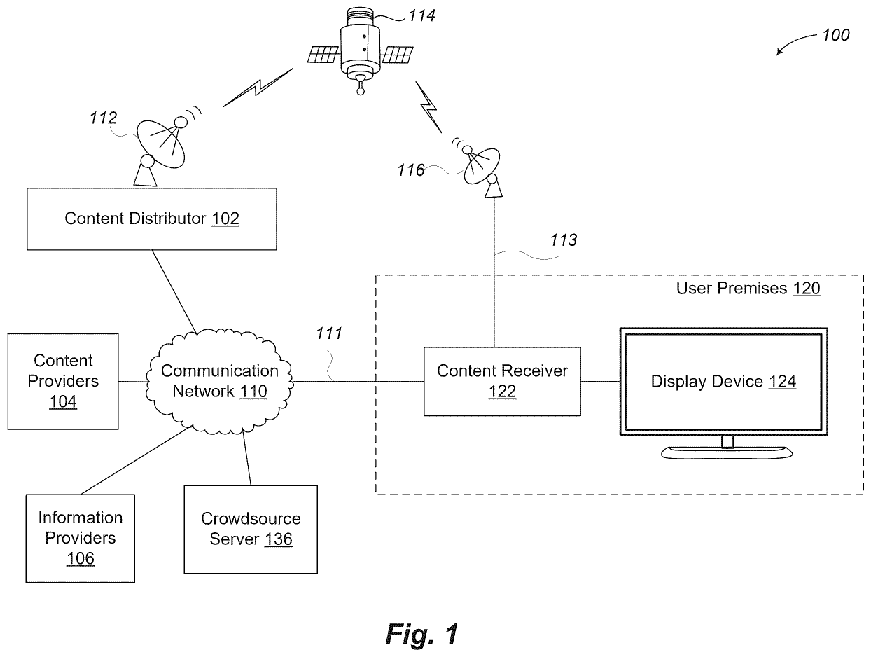

FIG. 1 illustrates a context diagram of an environment 100 for dynamically presenting personal information associated with individuals shown during presentation of content in accordance with embodiments described herein. Environment 100 includes content providers 104, information providers 106, content distributor 102, communication network 110, and user premises 120.

User premises 120 includes a content receiver 122 and a display device 124. The content receiver 122 is a computing device that receives audiovisual content for presentation to a user on the user premises 120 via the display device 124, and in some embodiments via one or more audio output devices (not illustrated). Examples of content receiver 122 may include, but are not limited to, a set-top box, a cable connection box, a computer, television receiver, radio receiver, or other content receivers. The display device 124 may be any kind of visual content display device, such as, but not limited to a television, monitor, projector, wearable devices (e.g., display headsets, smart glasses, etc.), or other display device.

Although FIG. 1 illustrates the content receiver 122 as providing content for display on a display device 124 located on the user premises 120, embodiments are not so limited. In some embodiments, the content receiver 122 provides the content to a user's mobile device (not illustrated), such as a smartphone, tablet, or other computing device, which is at a remote location to the user premises 120. In yet other embodiments, the content receiver 122 and the display device 124 may be integrated into a single computing device, such as a smart television, desktop computer, laptop computer, smart phone, tablet computer, etc.

The content receiver 122 is configured to receive content and present the content to a user via display device 124. The content receiver 122 is also configured to obtain personal information regarding an individual being shown in the content in response to user input and display it to the user, as described herein. Briefly, while the content is being presented to the user, the user can input an information request regarding an individual being shown in the content. For example, the user can speak into a microphone (not illustrated) asking who an individual (e.g., an actor or athlete) is within the content. The user can also request specific information about that individual (e.g., what movies are they in or how many goals have they scored this year). In response to receiving the user input, the content receiver 122 performs facial recognition on the content to identify the individual. In some embodiments, the content receiver 122 may provide the content (or a portion of the content) to another computing system to perform the facial recognition to identify the individual. In various embodiments, the content (or a portion of the content) and the user input may be input into one or more machine learning mechanisms trained to determine who the user is referring to (e.g., if the user asks “who is the person with the red hat sitting at the table”). Once the facial recognition determines the identity of the individual being shown in the content at the time when the user provided the input, the content receiver 122 uses the individual's identity to obtain (e.g., using an application programming interface (API)) personal information about that individual from one or more databases (not illustrated in FIG. 1). The personal information can then be presented to the user along with the content via the display device 124. In this way, the user can obtain information about an individual being shown in the content without knowing who that individual is or separately using another computing device (e.g., a smartphone) to search for the information.

In some embodiments, the example environment 100 may also include a crowdsource server 136. The crowdsource server 136 is configured to obtain or receive information requests associated with particular content from a plurality of content receivers 122. The crowdsource server 136 employs one or more machine learning mechanisms on the crowdsourced information requests to identify trends in what the users of the content receivers are requesting. The crowdsource server 136 can then select target content associated with the trends and provide the target content to one or more target users.

The following briefly discusses additional components in example environment 100. In various embodiments, the content distributor 102 provides content to the content receiver 122. The content distributor 102 may receive a plurality of different content from one or more content providers 104, one or more information providers 106, or a combination thereof. The content distributor 102 provides content and supplemental content, whether obtained from content provider 104 or the data from information provider 106, to a user through a variety of different distribution mechanisms. For example, in some embodiments, content distributor 102 may provide the content and data to a user's content receiver 122 directly through communication network 110 on link 111. In other embodiments, the content may be sent through uplink 112, which goes to satellite 114 and back to downlink station 116 that may also include a head end (not shown). The content is then sent to an individual content receiver 122 of a user/customer/viewer at user premises 120 via link 113.

Typically, content providers 104 generate, aggregate, and/or otherwise provide content that is provided to one or more users. Sometimes, content providers are referred to as “channels” or “stations.” Examples of content providers 104 may include, but are not limited to: film studios; television studios; network broadcasting companies; independent content producers, such as AMC, HBO, Showtime, or the like; radio stations; or other entities that provide content for user consumption. Content providers may also include streaming platforms, gaming system developers or providers, or other systems or companies that generate or distribute content. A content provider may also include individuals that capture personal or home videos and distribute these videos to others over various online media-sharing websites or other distribution mechanisms. The content provided by content providers 104 may be referred to as the program content, which may include movies, sitcoms, reality shows, talk shows, game shows, documentaries, infomercials, news programs, sports programs, songs, audio tracks, albums, or the like. In this context, program content may also include commercials or other television or radio advertisements. It should be noted that the commercials may be added to the program content by the content providers 104 or the content distributor 102. Embodiments described herein generally refer to content, which includes visual content, audio content, or audiovisual content that includes a video and audio component.

In at least one embodiment, information provider 106 creates and distributes data or other information that describes or supports content. Generally, this data is related to the program content provided by content provider 104. For example, this data may include metadata, program name, closed-caption authoring and placement within the program content, timeslot data, pay-per-view and related data, or other information that is associated with the program content. In some embodiments, the data or other information distributed by the information provider 106 does not include the information obtained for an individual identified in the content in response to user input, as described herein-in other embodiments, however, it does. In some embodiments, a content distributor 102 may combine or otherwise associate the data from information provider 106 and the program content from content provider 104, which may be referred to as the distributed content or more generally as content. However, other entities may also combine or otherwise associate the program content and other data together.

In at least one embodiment, communication network 110 is configured to couple various computing devices to transmit content/data from one or more devices to one or more other devices. For example, communication network 110 may be the Internet, X.25 networks, or a series of smaller or private connected networks that carry the content. Communication network 110 may include one or more wired or wireless networks, which may include cellular networks.

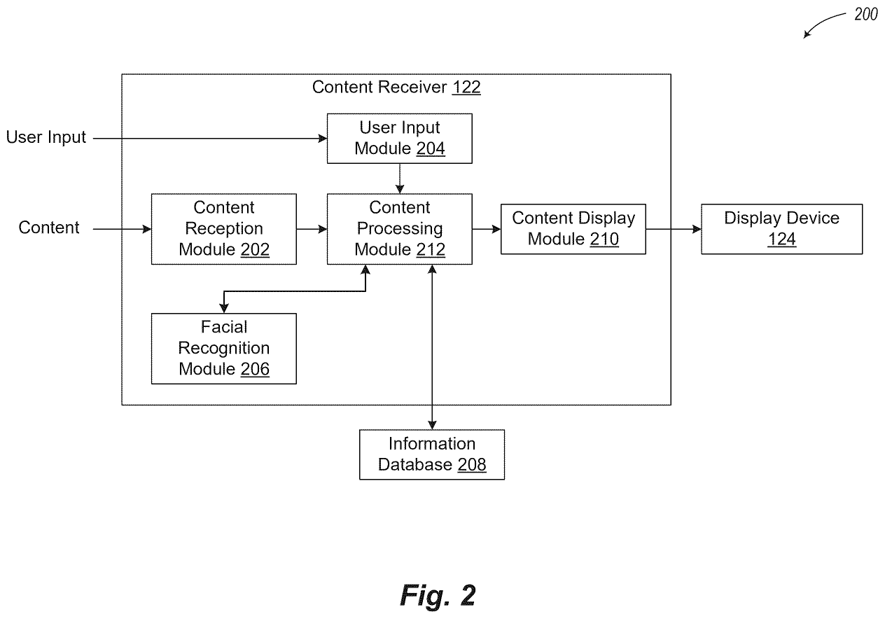

FIG. 2 illustrates a block diagram showing one embodiment of a system 200 for dynamically presenting personal information associated with individuals shown during presentation of content in accordance with embodiments described herein. The system 200 may include a content receiver 122, a display device 124, and an information database 208. Although illustrated separately, in some embodiments, the content receiver 122, the display device 124, and the information database 208, or some combination thereof, may be combined into a single computing system.

The information database 208 is configured to store information regarding a plurality of individuals, people, teams, or groups of people, or some combination thereof. Although FIG. 2 illustrates a single information database 208, embodiments are not so limited. Rather, one or a plurality of information databases may be stored in the content receiver 122, separate from the content receiver 122, or some combination thereof.

The content receiver may include a content reception module 202, a facial recognition module 206, a user input module 204, a content display module 210, and a content processing module 212. Although the content reception module 202, the facial recognition module 206, the user input module 204, the content display module 210, and the content processing module 212 are illustrated as separate modules, embodiments are not so limited. Rather, the functionality of the content reception module 202, the facial recognition module 206, the user input module 204, the content display module 210, and the content processing module 212 may be performed by a single module or component or by a plurality of modules or components.

The content reception module 202 is configured to receive content to display to a user via display device 124.

The user input module 204 is configured to receive input from a user of the content receiver 122. In some embodiments, the user input is a request for information regarding an individual being shown in the content. The information request may be a voice command received via a microphone or a button input command. In other embodiments, the user input may be a request for additional information of an individual previously identified by the content receiver 122. In various embodiments, the information request may also be input via other input mechanisms, such as by employing a camera to monitor the user for visual input cues (e.g., specific user gestures or tracking the gaze of the user).

In various embodiments, the content processing module 212 receives the user input from the user input module 204 and the content from the content reception module 202. The content reception module 202 provides the content or a portion of the content associated with the user input to the facial recognition module 206. In some embodiments, the content reception module 202 also provides the information request received via the user input to the facial recognition module 206. The content reception module 202 receives an indication of an individual identified in the content from the facial recognition module 206. The content reception module 202 queries the information database 208 for personal information associated with the identified individual. In some embodiments, the content processing module 212 may also query the information database 208 for additional information for a previously identified individual. The content processing module 212 is also configured to provide the content, and the obtained information, to the content display module 210.

The facial recognition module 206 is configured to identify the individual in the content in response to receipt of the request from the user via the user input module 204. The facial recognition module 206 may employ one or more types of facial recognition techniques on the content to identify individuals. Facial recognition techniques may employ geometric-based techniques, piecemeal/wholistic techniques, appearance-based/model-based techniques, statistical/neural network-based techniques, or others to detect or identify faces within images or video. In various embodiments, the facial recognition module 206 may include one or more machine learning mechanisms to identify faces of individuals in the content, determine which individual the user is asking about, and determine an identity of the individual based on the face of the individual. Examples of facial recognition techniques may include, but are not limited to, convolutional neural networks (CNN), Eigenfaces, Fisherfaces, Deepface, Principal Component Analysis, Haar Cascades, Three-dimensional recognition, skin texture analysis, adaptice neuro-fuzzy interface system (ANFIS), local binary patterns histograms, FaceNet, Support Vector Machine, etc. Once identified, the facial recognition module 206 provides an indication of the identity of the individual to the content processing module 212.

The content display module 210 is configured to receive the content from the content processing module 212 and display it to the user via display device 124. Once the content processing module 212 obtains information on an individual and provides it to the content display module 210, the content display module 210 displays the obtained information with the content to the user via the display device 124.

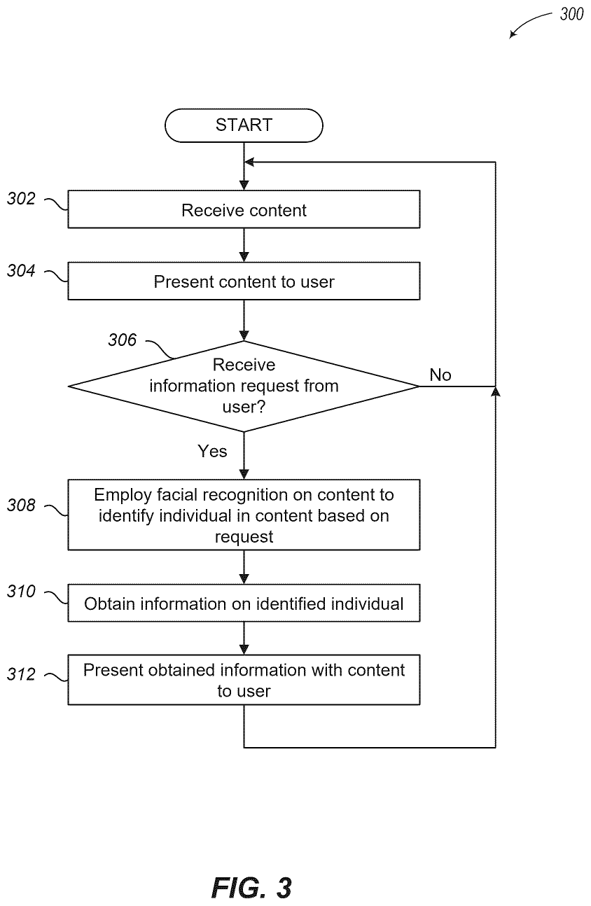

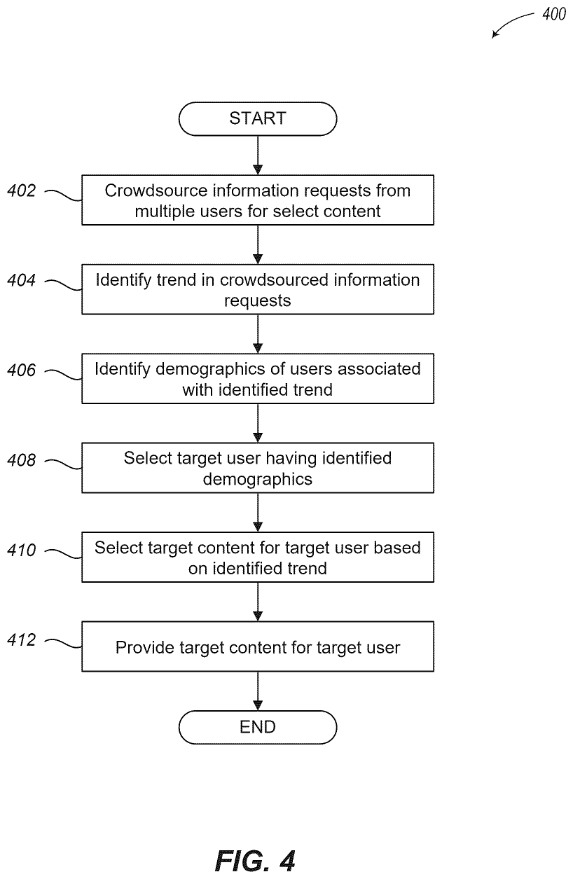

The operation of various embodiments and aspects will now be described with respect to FIGS. 3 and 4.

FIG. 3 illustrates a logical flow diagram showing one embodiment of a process 300 for dynamically presenting personal information associated with individuals shown during presentation of content in accordance with embodiments described herein. Process 300 may be implemented by one or more processors or executed via circuitry on one or more computing devices, such as content receiver 122 in FIG. 1.

Process 300 begins, after a start block, at block 302, where audiovisual content is received for presentation to a user. In various embodiments, the user may select the content to be presented, such as by selecting a television channel, selecting specific content (e.g., on-demand content), etc. The content may be a live broadcast (e.g., a sports event or a television awards show) or it may be previously recorded (e.g., a movie or television series re-run).

Process 300 proceeds, after block 302, to block 304, where the content is presented to a user. As the content is received by the content receiver, the content receiver provides, displays, or otherwise presents the content to the user via a display device.

Process 300 continues, after block 304, at decision block 306, where a determination is made whether an information request is received from the user. In various embodiments, this determination is made based on whether the user has provided an input requesting the information. In various embodiments, the user hold down a physical button on a remote control to enable a microphone on the remote control (or other device) to capture the user speaking the information request into the microphone. In some embodiments, the user input is converted from an audio information request to a text information request.

In general, the information request includes some details or utterance from the user about a particular individual or person (or a group of people or a team associated with a person) in a particular scene in the content. The request may include a person's name (e.g., “Is Joe married?”—in a scene that includes multiple people, one of which is Joe), a description of what a person is wearing (e.g., “Who is the person with the red hat?”), a location of a person within the scene (e.g., “Who is that on the far left of the table?”), an action being performed by a person (e.g., “Who is the woman driving the car?”), an utterance of a person (e.g., “who's that?”), etc. The information request may also include additional details specifying the type of information in which the user is interested. For example, “how many goals has that guy scored?” or “what movies has the guy riding the horse been in?”

If an information request is received from the user, then process 300 flows to block 308; otherwise, process 300 loops to block 302 to continue to receive content and present the content to the user.

At block 308, one or more facial recognition mechanisms are employed on the content to identify an individual shown in the content. Examples of such facial recognition mechanisms are describe herein, such as being performed by the facial recognition module 206 in FIG. 2.

In various embodiments, one video frame, or a plurality of video frames, is selected from the content relative to the user inputting the information request. For example, the video frame of the content that is currently being presented to the user when the user pushes a button on a remote control to enable a microphone to capture the information request from the user may be selected for facial recognition. As another example, the video frame or portion of the content that is being presented to the user when the user starts to utter the information request via a microphone. In some embodiments, this portion of the content may start a few frames (e.g., 5 frames) before the user provided the input and ends at the frame being presented at the time the user input. In at least one embodiment, the selected video frame (or multiple video frames) may be copied or otherwise obtained for facial recognition.

In some embodiments, the user unput may reference a previous scene within the content. For example, the user could say “who was that person on the horse?”—even though a horse is not currently visible in the content. The system can utilize image processing techniques, along with the input, to determine which scene the user was referencing. In some embodiments, the system may analyze a specific number of frames or images, or a number of frames or images within a delay timeframe prior to receiving the user input, to determine the scene being referenced by the user. Once the scene is determined, one or more images or frames in the determined scene can then be selected for facial recognition.

In various embodiments, the facial recognition mechanisms may detect individuals or people in motion video or still video frames. For example, the facial recognition mechanisms may detect faces within the selected video frame and then use specific facial recognition techniques to determine an identity of the individuals associated with the detected faces. The identity of the identified individual or person may be a name of that person or a unique identifier that corresponds to that person.

The facial recognition mechanisms may also accept additional prompts or commands as input to refine the identification of the individual being shown in the content. For example, if the information request includes “who is the person on the left of the table?”, the recognition mechanisms may first identify all faces within the selected video frame, identify a table within the selected video frame, select the identified face to the left of the identified table, and then determine the identity of the individual for the selected face. Other recognition mechanisms may be trained to aggregately perform these functions.

In some embodiments, the content receiver itself may perform the facial recognition on the content to identify an individual being shown in the content that is associated with the information request. In other embodiments, the content (e.g., the one or more selected video frames) may be transmitted to another computing system that is separate from the content receiver to perform the facial recognition. In some embodiments, the information request may also be transmitted to the other computing system with the content so as to perform the facial recognition on the content based on the information request. After the other computing system identifies an individual being shown in the content that is associated with the information request, the other computing system returns an indication (e.g., a person's name or a unique identifier that corresponds to a person) of the identified individual back to the content receiver.

Process 300 proceeds, after block 308, to block 310, where personal information on the identified individual is obtained. The personal information may include personal facts, career information, political information, statistics (e.g., sports stats), relationship information, or other details associated with the individual.

In various embodiments, the content receiver accesses one database or a plurality of databases or other data structures that store information regarding a plurality of individuals. The database may be stored on the content receiver, or it may be stored on a computing system that is separate from the content receiver. One example of such a database may be IMDB (Internet Movie Database). Another example database may include statistics of soccer players in a particular soccer league. The content receiver queries the one or more databases using the identifier or indication of the identified individual to retrieve or obtain the information on the identified individual. In some embodiments, the identifier or indication of the identified individual may be used to identify or select an appropriate database. For example, if the identifier for the identified individual is for an actor, then IMDB may be selected and queried by default. In other embodiments, the type of content may be used to identify or select the appropriate database. For example, if the content is a movie, then then IMDB may be selected and queried by default. In comparison, if the content is a soccer game, then the database of the soccer league may be selected and queried by default. In at least one embodiment, the user may input, select, or change the database that is to be queried for the identified individual.

Process 300 continues, after block 310, at block 312, where the obtained information is presented to the user along with the content. In some embodiments, a window, panel, ticker, or other graphical interface may be opened or presented to the user with the obtained information. In various embodiments, this other graphical interface is displayed simultaneously with the display of the content to the user. In some other embodiments, the obtained information may be presented to the user via audio output or transmitted to another device or system (e.g., sending a notification to the user's smartphone, sending an email to the user, etc.).

After block 312, process 300 loops to block 302 to continue to receive content and display the content to the user of the content receiver. Once reception of the content has ended, process 300 terminates or otherwise returns to a calling process to perform other actions.

In some embodiments, the user may be enabled to interact with the obtained information while it is being presented to the user to obtain additional information regarding the identified individual. For example, if the initial information request is “who is the person on the left of the table?”, the obtained information may include the person's name and two or three movies in which that person has acted. The user can interact with the graphical interface to request additional information on those movies or to see additional movies in which that person has acted. In response to this additional information request, the content receiver can query the same database or one or more other databases to obtain the additional requested information. In yet other embodiments, the user can set flags, recordings, or reminders of shows or movies listed in the obtained information.

Although process 300 is described as performing facial recognition on content to identify an individual being shown in the content and then obtaining personal information on the identified individual, embodiments are not so limited. In some other embodiments, process 300 may employ other object recognition techniques on the content to identify objects within the content.

One or more object databases can then be queried to obtain information on the identified objects.

For example, while presenting content (e.g., a television award show) to the user, the user can input an information request for an object being shown in the content (e.g., as determined at decision block 306). By way of illustrative example, the user could utter the question “who makes that red dress?” or “where can I buy that blue hat?” The system then performs object recognition techniques on the content to identify the particular object being referred to by the user (e.g., at block 308).

Once identified, one or more object databases may be queried for information regarding the identified object (e.g., at block 310), and the obtained object information is presented to the user (e.g., at block 312). Such information may identify the name of the object, where the object can be purchased, the name of the company that makes the object, dimensions of the object, properties of the object, etc. In this way, embodiments described herein can be expanded to objects or items other than individuals.

FIG. 4 illustrates a logical flow diagram showing one embodiment of a process 400 for crowdsourcing personal-information requests to select target content for a target user in accordance with embodiments described herein. Process 400 may be implemented by one or more processors or executed via circuitry on one or more computing devices, such as content receiver 122 or crowdsource server 136 in FIG. 1.

Process 400 begins, after a start block, at block 402, where information requests are crowdsourced from multiple users for select content. Content receivers of a plurality of users may employ process 300 in FIG. 3 for the select content. For each employment of process 300 users may provide an information request during the presentation of the select content. These information requests may be obtained from the content receivers of the plurality of users, which is collectively referred to as crowdsourced information requests. For example, if the select content is a television awards show, then all information requests made by the plurality of people watching the television awards show are crowdsourced and obtained as the crowdsourced information requests. The crowdsourced information requests may include the requests themselves, the indications of the identified individuals, the obtained information on the identified individuals, user interactions with the obtained information, etc. By obtaining information requests from multiple users, trends within those requests can be determined and used to select and provide content to a target user.

In some embodiments, the particular content receivers that are presenting the select content to users are queried for any information requests made by those users. In other embodiments, the content receivers may automatically provide or upload information requests made by users. In some embodiments, the information requests may be crowdsourced from a specific geographic area or from a specific demographic of users.

Process 400 proceeds, after block 402, to block 404, where one or more trends in the crowdsourced information requests is identified. In some embodiments, one or more machine learning or artificial intelligence mechanisms or models (e.g., convolutional neural networks, artificial neural networks, support vector machines, etc. or combinations thereof) that are trained to identify trends in data may be employed on the crowdsourced information requests. Information requests, identified individuals, obtained information, or user interactions with obtained information may be input to the trained machine learning or artificial intelligence mechanisms or models, which can then output one or more trends. In other embodiments, one or more statistical models may be employed to determine similarities or patterns within the crowdsourced information.

As one example, the system may identify one trend as multiple users requested information on the same individual being shown in the content (e.g., a particular actor). As another example, the system may identify another trend as multiple users requested information on a particular type of dress being worn by multiple individuals being shown in the content. Accordingly, the trends may be based on the information requests themselves or from the information obtained based on those requests. In yet other embodiments, the trends may be based on the user interactions with the obtained information (e.g., multiple people set a recording for a particular movie, even if they requested information on different people).

Process 400 continues, after block 404, at block 406, where demographics of the users associated with the identified trends are identified. Demographic information may include geographic area, age, gender, content preferences, etc. In some embodiments, the demographic information is obtained with the information requests from the content receivers. In other embodiments, a separate server may store this demographic information.

Process 400 proceeds, after block 406, to block 408, where a target user is selected as having the identified demographics. In some embodiments, the target user is a user that shares the same demographics as the users associated with the identified trends. In other embodiments, the target user is a user who also consumed the select content.

Process 400 continues, after block 408, at block 410, where target content for the target user is selected based on the identified trend. In some embodiments, the target content is specifically identified from the trend itself. For example, assume the crowdsourced information requests were obtained from users who watch a particular television awards show, and the target user also watched the same television awards show. If the trend in the crowdsourced information requests was to obtain information on a particular actor and then record a particular movie of that actor, then the target content selected for the target user may be that same particular movie. In other embodiments, the target content may be selected as being associated with the trend. Using the same example as above, the target content may be a different movie of the same particular actor associated with the identified trend.

Process 400 proceeds, after block 410, to block 412, where the target content is provided for the target user. In some embodiments, the target content is transmitted to or distributed to the content receiver of the target user. In other embodiments, the content receiver of the target user may be commanded to set a flag, recording, or reminder for the target user to later consume the target content. In some other embodiments, the content receiver may add an identifier of the target content to a favorites list for the target user.

After block 412, process 400 terminates or otherwise returns to a calling process to perform other actions.

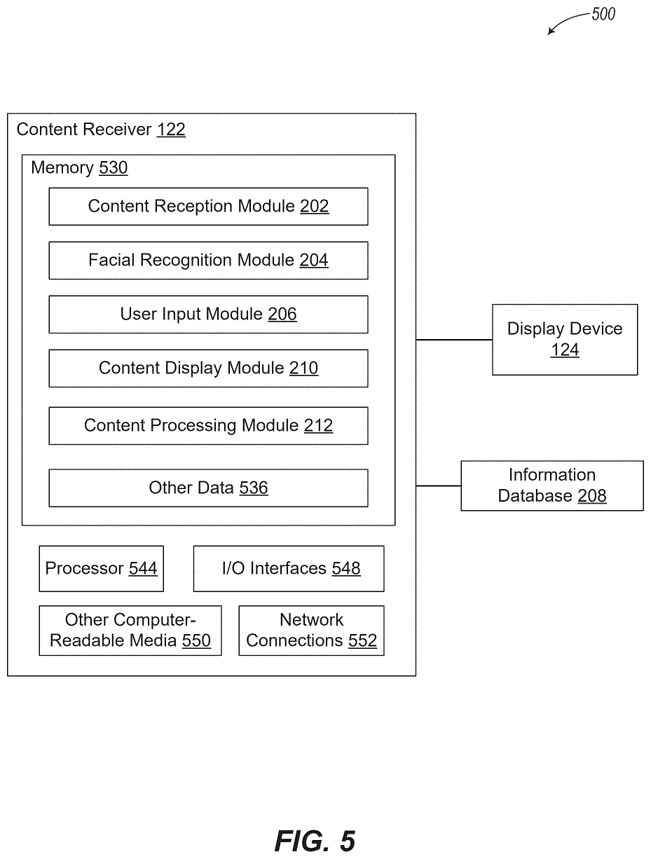

FIG. 5 shows a system diagram that describes various implementations of computing systems for implementing embodiments described herein. System 500 includes content receiver 122, display device 124, and information database 208.

Content receiver 122 receives and provides content for presentation to a user via display device 124. In general, the content receiver 122 enables the user to request information regarding an individual within the content currently being displayed, employ facial recognition to identify the individual, obtain information on the individual, and display the information along with the content, as described herein. One or more special-purpose computing systems may be used to implement content receiver 122. Accordingly, various embodiments described herein may be implemented in software, hardware, firmware, or in some combination thereof. Content receiver 122 may include memory 530, processor 544, I/O interfaces 548, other computer-readable media 550, and network connections 552.

Memory 530 may include one or more various types of non-volatile and/or volatile storage technologies. Examples of memory 530 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 530 may be utilized to store information, including computer-readable instructions that are utilized by processor 544 to perform actions, including embodiments described herein.

Processor 544 includes one or more processors, one or more processing units, programmable logic, circuitry, or one or more other computing components that are configured to perform embodiments described herein or to execute computer instructions to perform embodiments described herein. In some embodiments, a processor system of the content receiver 122 may include a single processor 544 that operates individually to perform actions. In other embodiments, a processor system of the content receiver 122 may include a plurality of processors 544 that operate to collectively perform actions, such that one or more processors 544 may operate to perform some, but not all, of such actions. Reference herein to “a processor system” of the content receiver 544 refers to one or more processors 544 that individually or collectively perform actions. And reference herein to “the processor system” of the content receiver 122 refers to 1) a subset or all of the one or more processors 544 comprised by “a processor system” of the content receiver 122 and 2) any combination of the one or more processors 544 comprised by “a processor system” of the content receiver 122 and one or more other processors 544.

Memory 530 may have stored thereon a content reception module 202, a facial recognition module 206, a user input module 204, a content display module 210, and a content processing module 212. The content reception module 202 is configured to receive content to display to a user via the display device 124. The user input module 206 is configured to receive a request for information regarding an individual in the content. The facial recognition module 204 is configured to identify the individual in the content in response to receipt of the request from the user. the content processing module 212 is configured to obtain information on the individual identified by the facial recognition module. And the content display module 210 is configured to display the obtained information with the content to the user via the display device 124. The memory 530 may also store other data or programs 536 (e.g., operating systems, user profiles, information databases, etc.).

Network connections 552 are configured to communicate with other computing devices, such as display device 124 or information database 208. I/O interfaces 548 may include a keyboard, audio interfaces, video interfaces, or the like. Other computer-readable media 550 may include other types of stationary or removable computer-readable media, such as removable flash drives, external hard drives, or the like.

Although not illustrated, the crowdsource server 136 may include computing components similar to content receiver 122 or include circuitry to perform functionality of the crowdsource server 136, as described herein.

The following is a summarization of the claims as originally filed.

A method may be performed by a content receiver and summarized as comprising: receiving video content to present to a user of the content receiver and presenting the video content to the user via a display device. During presentation of the video content to the user, the method may include: receiving user input requesting information regarding an individual being shown in the video content; and in response to receiving the user input: employing a facial recognition mechanism on the video content to identify the individual being shown in the video content; obtaining information on the identified individual; and presenting the obtained information with the video content to the user via the display device.

The method may employ the facial recognition mechanism on the content to identify the individual, including: selecting a video frame of the video content relative to the user input being received; transmitting the selected video frame to another computing system to perform the facial recognition mechanism on the selected video frame to identify the individual being shown in the video content; and receiving an indication of the identified individual from the other computing system.

The method may employ the facial recognition mechanism on the content to identify the individual, including: selecting a video frame of the video content having a timestamp associated with receipt of the user input; and performing the facial recognition mechanism on the selected video frame to identify the individual being shown in the video content.

The method may receive the user input including: capturing an utterance from the user via a microphone; determining a start of the utterance; and identifying a portion of the video content that corresponds to the start of the utterance, wherein the portion is provided to the facial recognition mechanism to identify the individual being shown in the video content.

The method may obtain the information on the identified individual, including: accessing a database using an indication of the identified individual to obtain the information on the identified individual.

The method may further comprise during the presentation of the video content to the user: receiving a second user input requesting additional information regarding the identified individual; obtaining the additional information on the identified individual; and presenting the additional information with the video content to the user via the display device.

The method may further comprise: receiving crowdsourced information requests from a plurality of users; identifying a trend in the crowdsourced information requests relative to the user; selecting other content for the user based on the identified trend; and providing the other content to the user. In some embodiments, the method may provide the other content to the user, including: adding an identifier of the other content to a favorites list of the user. In other embodiments, the method provide the other content to the user, including: presenting the other content to the user via the display device.

A content receiver may be summarized as comprising: a memory configured to store computer instructions; and a processor system configured to execute the computer instructions to: receive content to display to a user and display the content to the user via a display device. While the content is being displayed during to the user, the processor system is configured to execute the computer instructions to: receive a request from the user for information regarding a person in the content; and in response to receiving the request: identify the person in the content by employing a facial recognition mechanism on the content; obtain information on the identified person; and display the obtained information with the content to the user via the display device.

The processor system of the content receiver identifies the person in the content by being configured to further execute the computer instructions to: select a video frame of the content that corresponds to receipt of the request from the user; provide the selected video frame to another computing system to perform the facial recognition mechanism on the selected video frame to identify the person in the content that corresponds to the request; and receive an indication of the identified person from the other computing system.

The processor system of the content receiver identifies the person in the content by being configured to further execute the computer instructions to: select a video frame of the content having a timestamp associated with receipt of the request from the user; and perform the facial recognition mechanism on the selected video frame to identify the person in the content.

The processor system of the content receiver receives the request from the user by being configured to further execute the computer instructions to: capture an utterance from the user via a microphone; determine a start of the utterance; and identify a portion of the content that corresponds to the start of the utterance, wherein the portion is provided to the facial recognition mechanism to identify the person in the content.

The processor system of the content receiver obtains the information on the identified person by being configured to further execute the computer instructions to: access a database using a name of the identified person to obtain the information on the identified person.

The processor system of the content receiver is configured to further execute the computer instructions to: receive a second request from the user for additional information regarding the identified person; obtain the additional information on the identified person; and display the additional information with the content to the user via the display device.

The processor system of the content receiver is configured to further execute the computer instructions to: receive crowdsourced information requests from a plurality of users of other content receivers; identify a trend in the crowdsourced information requests relative to the user; select other content for the user based on the identified trend; and provide the other content to the user. In some embodiments, the processor system of the content receiver provides the other content to the user by being configured to further execute the computer instructions to: add an identifier of the other content to a favorites list of the user. In other embodiments, the processor system of the content receiver provides the other content to the user by being configured to further execute the computer instructions to: display the other content to the user via the display device.

A system may be summarized as comprising: a content reception module configured to receive content to display to a user; a user input module configured to receive a request for information regarding a person in the content; a facial recognition module configured to identify the person in the content in response to receipt of the request from the user; a content processing module configured to obtain information on the person identified by the facial recognition module; and a content display module configured to display the obtained information with the content to the user via a display device.

The system may further comprise: an information database configured to store information regarding a plurality of people; and wherein the content display module is further configured to obtain the information on the person from the information database.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, by a content receiver, video content to present to a user of the content receiver;
presenting, by the content receiver, the video content to the user via a display device; and
during presentation of the video content to the user:
receiving, by the content receiver, user input requesting information regarding an individual being shown in the video content; and
in response to receiving the user input:
selecting, by the content receiver, a video frame of the video content relative to the user input being received;
transmitting, by the content receiver, the selected video frame to a remote computing system to perform facial recognition on the selected video frame to identify the individual being shown in the video content;
receiving, by the content receiver, an identifier of the identified individual from the remote computing system;
obtaining, by the content receiver, information on the identified individual using the received identifier; and
presenting, by the content receiver, the obtained information with the video content to the user via the display device.

2. (canceled)

3. The method of claim 1, wherein selecting the video frame of the video content relative to the user input, comprises:
selecting, by the content receiver, the video frame of the video content having a timestamp associated with receipt of the user input.

4. The method of claim 1, wherein receiving the user input, comprises:
capturing, by the content receiver, an utterance from the user via a microphone;
determining, by the content receiver, a start of the utterance; and
identifying, by the content receiver, a portion of the video content that corresponds to the start of the utterance, wherein the portion is provided to the facial recognition mechanism to identify the individual being shown in the video content.

5. The method of claim 1, wherein obtaining the information on the identified individual, comprises:
accessing, by the content receiver, a database using the received identifier of the identified individual to obtain the information on the identified individual.

6. The method of claim 1, further comprising during the presentation of the video content to the user:
receiving, by the content receiver, a second user input requesting additional information regarding the identified individual;
obtaining, by the content receiver, the additional information on the identified individual; and
presenting, by the content receiver, the additional information with the video content to the user via the display device.

7. The method of claim 1, further comprising:
receiving, by the content receiver, crowdsourced information requests from a plurality of users;
identifying, by the content receiver, a trend in the crowdsourced information requests relative to the user;
selecting, by the content receiver, other content for the user based on the identified trend; and
providing, by the content receiver, the other content to the user.

8. The method of claim 7, wherein providing the other content to the user, comprises:
adding, by the content receiver, an identifier of the other content to a favorites list of the user.

9. The method of claim 7, wherein providing the other content to the user, comprises:
presenting, by the content receiver, the other content to the user via the display device.

10. A content receiver, comprising:
a memory configured to store computer instructions; and
a processor system configured to execute the computer instructions to:
receive content to display to a user;
display the content to the user via a display device; and
while the content is being displayed during to the user:
receive a request from the user for information regarding a person in the content; and
in response to receiving the request:
identify a previous scene of the content referenced by the user in the request, the previous scene being prior to a current scene of the content;
identify the person in the previous scene of the content by employing a facial recognition mechanism on the content;
obtain information on the identified person; and
display the obtained information with the content to the user via the display device.

11. The content receiver of claim 10, wherein the processor system identifies the person in the content by being configured to further execute the computer instructions to:
select a video frame from the previous scene of the content that corresponds to the reference by the user;
provide the selected video frame to another computing system to perform the facial recognition mechanism on the selected video frame to identify the person in the content that corresponds to the request; and
receive an indication of the identified person from the other computing system.

12. (canceled)

13. The content receiver of claim 10, wherein the processor system receives the request from the user by being configured to further execute the computer instructions to:
capture an utterance from the user via a microphone;
identify the request from the utterance captured from the user.

14. The content receiver of claim 10, wherein the processor system obtains the information on the identified person by being configured to further execute the computer instructions to:
access a database using a name of the identified person to obtain the information on the identified person.

15. The content receiver of claim 10, wherein the processor system is configured to further execute the computer instructions to:
receive a second request from the user for additional information regarding the identified person;
obtain the additional information on the identified person; and
display the additional information with the content to the user via the display device.

16. The content receiver of claim 10, wherein the processor system is configured to further execute the computer instructions to:
receive crowdsourced information requests from a plurality of users of other content receivers;
identify a trend in the crowdsourced information requests relative to the user;
select other content for the user based on the identified trend; and
provide the other content to the user.

17. The content receiver of claim 16, wherein the processor system provides the other content to the user by being configured to further execute the computer instructions to:
add an identifier of the other content to a favorites list of the user.

18. The content receiver of claim 16, wherein the processor system provides the other content to the user by being configured to further execute the computer instructions to:
display the other content to the user via the display device.

19. A system, comprising:
a crowdsource server configured to:
receive crowdsourced information requests for content from a plurality of users;
identify a trend in the crowdsourced information requests relative to a user;
select the content for the user based on the identified trend; and
provide the content to the user; and
a content receiver including:
a content reception module configured to receive the content to display to a-the user;
a user input module configured to receive a request for information regarding a person in the content;
a facial recognition module configured to identify the person in the content in response to receipt of the request from the user;
a content processing module configured to obtain information on the person identified by the facial recognition module; and
a content display module configured to display the obtained information with the content to the user via a display device.

20. The system of claim 19, further comprising:
an information database configured to store information regarding a plurality of people; and
wherein the content display module is further configured to obtain the information on the person from the information database.
